(19) United States
(12) Patent Application Publication
(10) Pub. No.: US 2022/0105652 A1
(43) Pub. Date: Apr. 7, 2022

(54) BALE RUBBER HOLDING DEVICE AND METHOD FOR CUTTING BALE RUBBER

(71) Applicant: Toyo Tire Corporation, Itami-shi (JP)

(72) Inventors: Hiroki Tanabe, Itami-shi (JP); Takaho Korekawa, Itami-shi (JP)

(73) Assignee: Toyo Tire Corporation, Itami-shi (JP)

(21) Appl. No.: 17/339,075

(22) Filed: Jun. 4, 2021

(30) Foreign Application Priority Data
Oct. 7, 2020 (JP) 2020-170181

(51) Int. Cl. B26D 7/02; B26D 3/00

(52) U.S. Cl. CPC B26D 7/02; B26D 2007/011; B26D 3/003

(57) ABSTRACT

Provided is a bale rubber holding device 54 of an embodiment which is provided in a feeding device 50 which feeds a bale rubber 20, which is a lump of rubber, forward toward a cutting position, where the bale rubber holding device 54 grips a rear portion of the bale rubber 20.

### CROSS-REFERENCE TO RELATED APPLICATIONS

This application is based on Japanese patent application 2020-170181 (filed on Oct. 7, 2020) and enjoys preferential benefits from this application. This application shall include all of the contents of Japanese Patent Application 2020-170181 by reference to Japanese Patent Application 2020-170181.

### TECHNICAL FIELD

The present invention relates to a bale rubber holding device and a method for cutting a bale rubber.

### BACKGROUND ART

A rubber mixture used as a material of a tire is prepared by mixing raw material rubber, a reinforcing material, a functional material, and the like in a predetermined ratio. As the raw material rubber used here, a bale rubber piece cut out from a bale rubber, which is a relatively large mass of rubber, is used.

A bale rubber is delivered to a factory in a form of being wrapped in a resin sheet which does not affect properties of the rubber mixture. The delivered bale rubber is cut by a cutter coming down from above and divided into a plurality of bale rubber pieces as described in PTL 1, and here, the bale rubber is cut together with the resin sheet while being wrapped in the resin sheet.

Normally, a bale rubber is intermittently fed toward a cutting position, and each time it is fed, it is cut by a cutter to cut out a bale rubber piece. In the related art, the bale rubber is fed to the cutting position by pushing a rear portion (a portion opposite to a feeding direction) of the bale rubber.

PTL 1: JP-A-2002-18785

### SUMMARY OF THE INVENTION

### Problem that the Invention is to Solve

However, since a bale rubber is sticky to a cutter, in a method of the related art, a cut surface of a bale rubber and a rear potion of a bale rubber are lifted when cutting the bale rubber. As a result, a position of the bale rubber may shift. When a resin sheet covering the bale rubber is not cut even when the bale rubber is cut, the position of the bale rubber might shift due to being pulled by the resin sheet. Then, there is a problem that the bale rubber piece cannot be cut out with accurate dimensions at next cutting due to the misalignment of the bale rubber.

Therefore, an object of the invention is to provide a device and a method for facilitating cutting out a bale rubber piece with accurate dimensions.

### Means for Solving the Problem

According to a bale rubber holding device of an embodiment, there is provided a bale rubber holding device which is provided in a feeding device which feeds a bale rubber, which is a lump of rubber, forward toward a cutting position, where the bale rubber holding device grips a rear portion of the bale rubber.

According to a method for cutting a bale rubber of an embodiment, there is provided a method for cutting a bale rubber which includes feeding the bale rubber forward toward a cutting position and cutting the bale rubber at the cutting position, where at least while the bale rubber is cut, a bale rubber holding device provided in a feeding device which feeds the bale rubber grips a rear portion of the bale rubber.

### Advantage of the Invention

According to the embodiment, it becomes easy to cut out a bale rubber piece with accurate dimensions.

### BRIEF DESCRIPTION OF THE DRAWINGS

FIG. 1 is a perspective view of a cutting device.

FIG. 2 is a plan view of the cutting device.

FIG. 3 is a block diagram of the cutting device.

FIG. 4 is a perspective view of a bale rubber holding device as viewed from the front. A length measurement sensor is omitted in FIGS. 4 to 7.

FIG. 5 is a perspective view of the bale rubber holding device as viewed from the rear.

FIG. 6 is a plan view of the bale rubber holding device.

FIG. 7 is a plan view of the bale rubber holding device when gripping a bale rubber.

FIG. 8 is a cross-sectional view taken along the line A-A of FIG. 2, when the bale rubber is on a constant-rate feed conveyor.

FIG. 9 is a cross-sectional view taken along the line A-A of FIG. 2, when the bale rubber moves to a position contacting a first cutter.

FIG. 10 is a cross-sectional view taken along the line A-A of FIG. 2, when the bale rubber moves to under the first cutter.

FIG. 11 is a cross-sectional view taken along the line A-A of FIG. 2, when the bale rubber is cut by the first cutter.

FIG. 12 is a flowchart of a method for determining a feed distance of the bale rubber.

FIG. 13 is a perspective view of a bale rubber holding device of a modification example.

### MODE FOR CARRYING OUT THE INVENTION

An embodiment will be described with reference to the drawings. The embodiment described below is merely an example and those which are appropriately modified without departing from a spirit of the present invention shall be included in a scope of the present invention.

1. Overall Configuration of Cutting Device

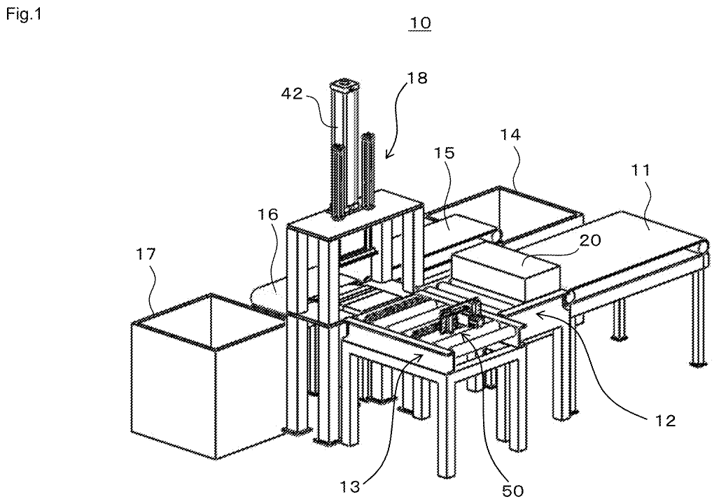

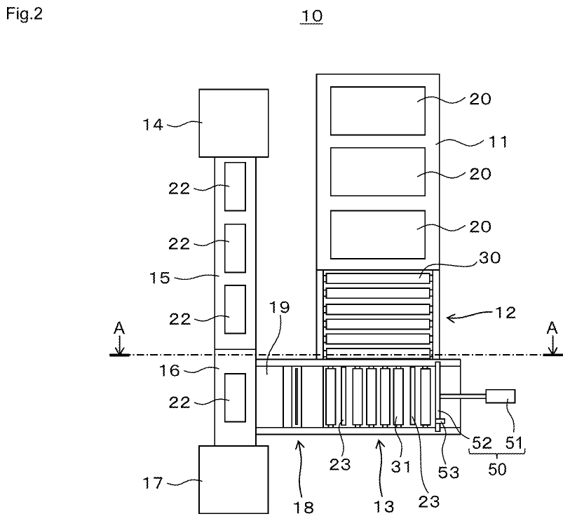

As illustrated in FIGS. 1 and 2, in a cutting device 10, a preparation conveyor 11, a first measurement conveyor 12, and a constant-rate feed conveyor 13 are arranged in a row in this order. Next to the conveyors 11, 12, and 13, a non-defective product box 14, a non-defective product transport conveyor 15, a second measurement conveyor 16, and a defective product box 17 are arranged in a row in this order. The two rows are parallel. A cutting portion 18 and a discharge conveyor 19 are provided between the constant-rate feed conveyor 13 and the second measurement conveyor 16. The cutting portion 18 is arranged on the constant-rate feed conveyor 13 side and the discharge conveyor 19 is arranged on the second measurement conveyor 16 side.

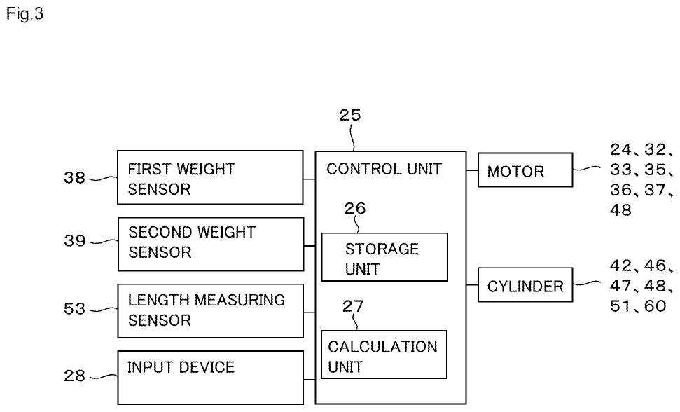

The preparation conveyor 11 is a belt conveyor. A bale rubber 20 is arranged on the preparation conveyor 11. The bale rubber 20 is a mass of rubber as a raw material for a tire, is substantially rectangular parallelepiped shape, and is packaged with a resin sheet (not illustrated). The preparation conveyor 11 rotates in a direction of moving the bale rubber 20 on the preparation conveyor 11 toward the first measurement conveyor 12. The preparation conveyor 11 is rotated by being driven by a motor 35 (see FIG. 3).

The first measurement conveyor 12 is a roller conveyor composed of a plurality of rollers 30. The roller 30 can rotate in a direction of moving the bale rubber 20 which has moved from the preparation conveyor 11 to the constant-rate feed conveyor 13. The roller 30 is rotated by being driven by a motor 36 (see FIG. 3). The plurality of rollers 30 are provided on a first weight sensor 38 (see FIG. 3) and the weight of the bale rubber 20 placed on the rollers 30 can be measured by the first weight sensor 38. The first weight sensor 38 may be located under the roller 30 while the bale rubber 20 is moving and may rise above the roller 30 when the bale rubber 20 is stopped to measure the weight of the bale rubber 20.

The constant-rate feed conveyor 13 is a roller conveyor including a plurality of rollers 31. The roller 31 is a rotatable free roller and can rotate in a direction orthogonal to the rotation direction of the roller 30 of the first measurement conveyor 12.

A snap cover chain 23 which moves up and down with respect to the constant-rate feed conveyor 13 is provided. The snap cover chain 23 is an endless chain which rotates in the same direction as a transport direction of the first measurement conveyor 12 when driven by a motor 24 (see FIG. 3). The snap cover chain 23 is provided at a gap between the roller 31 and the roller 31 of the constant-rate feed conveyor 13. Then, the snap cover chain 23 rises above the roller 31 or descends below the roller 31 by a cylinder 48 (see FIG. 3). The bale rubber 20 is transported from the first measurement conveyor 12 to a vicinity of a center of the constant-rate feed conveyor 13 by the snap cover chain 23.

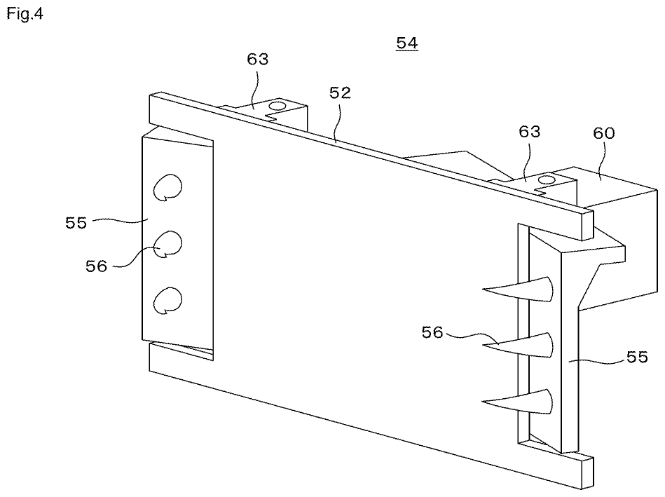

A feeding device 50 is provided on the constant-rate feed conveyor 13. The feeding device 50 includes a cylinder 51 which operates with liquid or gas and a plate-shaped push plate 52 attached to a tip of a rod of the cylinder 51. The push plate 52 is provided with a bale rubber holding device 54 (see FIGS. 4 to 7) capable of gripping a rear end portion of the bale rubber 20. When the rod of the cylinder 51 advances, the push plate 52 pushes and feeds the bale rubber 20 on the constant-rate feed conveyor 13 toward the cutting portion 18. In the following description, a direction in which the feeding device 50 sends out the bale rubber 20 is referred to as “forward” and an opposite direction is referred to as “rear”. While the push plate 52 pushes the bale rubber 20, the bale rubber holding device 54 grips a rear end portion of the bale rubber 20. The bale rubber holding device 54 will be described below.

A servomotor may be used instead of the cylinder 51 as a device for moving the push plate 52.

A length measuring sensor 53 is provided on the push plate 52. When a first cutter 40, which will be described below, of the cutting portion 18 is lowered, the length measuring sensor 53 can measure a distance from the push plate 52 to the first cutter 40.

The cutting portion 18 is a portion which cuts the bale rubber 20 sent from the constant-rate feed conveyor 13 into a bale rubber piece 22. As will be described below, the cutting portion 18 is provided with the first cutter 40 which descends toward the bale rubber 20 and a second cutter 41 which rises toward the bale rubber 20.

The discharge conveyor 19 is a belt conveyor. The discharge conveyor 19 can rotate in the same direction as the rollers 31 of the constant-rate feed conveyor 13. The discharge conveyor 19 is rotated by being driven by a motor 33 (see FIG. 3). The discharge conveyor 19 is inclined to be high on a cutting portion 18 side and low on a second measurement conveyor 16 side. The bale rubber piece 22 formed by being cut by the cutting portion 18 is conveyed to the second measurement conveyor 16 by the discharge conveyor 19.

The discharge conveyor 19 may be composed of a plurality of free rollers. Instead of the discharge conveyor 19, a sliding plate inclined with respect to a horizontal plane may be used.

The second measurement conveyor 16 is a belt conveyor. The second measurement conveyor 16 can rotate in a direction parallel to the preparation conveyor 11 and the first measurement conveyor 12. The second measurement conveyor 16 is rotated by being driven by a motor 37 (see FIG. 3).

The defective product box 17 is arranged on one side of a rotation direction of the second measurement conveyor 16 and the non-defective product transport conveyor 15 and the non-defective product box 14 are arranged on the other side. The second measurement conveyor 16 is provided on a second weight sensor 39 (see FIG. 3) and a weight wₙ (the weight of the bale rubber piece 22 cut out at the n-th time) of the bale rubber piece 22 placed on the second measurement conveyor 16 can be measured by the second weight sensor 39. When the weight of the bale rubber piece 22 is within a reference value, the second measurement conveyor 16 rotates in a direction of the non-defective product box 14, and when the weight of the bale rubber piece 22 exceeds the reference value, the second measurement conveyor 16 rotates in a direction of the defective product box 17.

The non-defective product transport conveyor 15 is a belt conveyor. The non-defective product transport conveyor 15 transports the bale rubber piece 22 sent from the second measurement conveyor 16 to the non-defective product box 14. The non-defective product transport conveyor 15 is rotated by being driven by a motor 32 (see FIG. 3).

As illustrated in FIG. 3, the cutting device 10 is provided with a control unit 25. The control unit 25 includes a storage unit 26, a calculation unit 27, and the like.

The first weight sensor 38, the second weight sensor 39, the length measuring sensor 53, motors 24, 32, 35, 36, and 37, cylinders 42, 46, 47, 48, and 51, and the like are connected to the control unit 25. An input device 28 for inputting manufacturing conditions and the like to the control unit 25 is also connected to the control unit 25. The control unit 25 controls the motors 24, 32, 35, 36, and 37, the cylinders 42, 46, 47, 48, 51, and 60, and the like based on measured values of the connected sensors and input values from the input device 28.

2. Configuration of Bale Rubber Holding Device

As illustrated in FIGS. 4 to 7, the bale rubber holding device 54 includes plate-shaped movable portions 55 provided on both the left and right sides (In the description of the bale rubber holding device 54, left and right are one side and the other side in a width direction of the push plate 52) of the push plate 52 and claws 56 provided to project forward from a front surface of the movable portion 55. A plurality of (three in the drawing) claws 56 are provided for one movable portion 55 and the claws 56 are arranged in a row in an up-down direction. Each claw 56 is curved toward the center in the width direction of the push plate 52 and has a sharp tip.

A horizontal plate-shaped extension portion 57 is provided to extend from the movable portion 55 toward a back side (the side opposite to the front side in a feeding direction) of the push plate 52. The extension portion 57 is extended to a position beyond a center in the width direction of the push plate 52 on the back side of the push plate 52. An elongated hole 58 is formed in a vicinity of the center of the push plate 52 in the width direction to penetrate the extension portion 57 in the up-down direction. The elongated hole 58 extends in an extension direction of the extension portion 57.

The bale rubber holding device 54 further includes a cylinder 60 fixed by a fixing member 59 to the back surface of the push plate 52 and a rod member 62 provided at a tip of a rod 61 of the cylinder 60. The rod member 62 is a single rod-shaped member extending in the up-down direction. The rod member 62 vertically penetrates the elongated holes 58 of the left and right extension portions 57.

On the left and right sides of the back surface of the push plate 52, shaft member holding portions 63 projecting rearward are provided. On both the left and right sides, the shaft member holding portions 63 respectively hold shaft members 64 extending in the up-down direction.

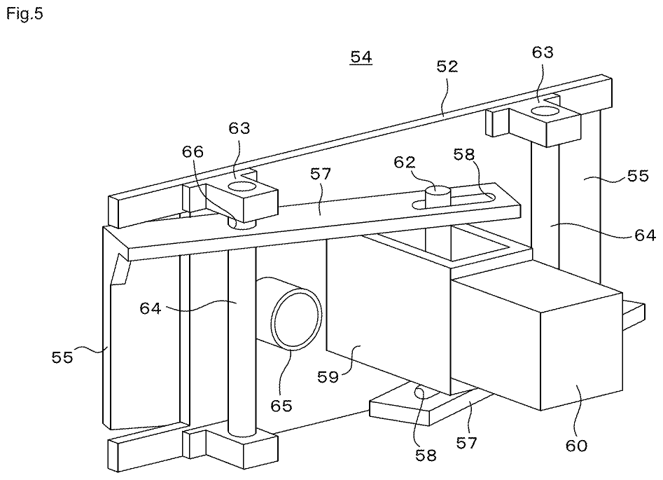

The shaft members 64 on both the left and right sides respectively penetrate holes 66 (see FIG. 5) formed in the extension portions 57 on both the left and right sides in the up-down direction. The extension portion 57 and the movable portion 55 integrated with the extension portion 57 can be displaced by a predetermined angle in a rotation direction with the shaft member 64 as a rotation axis.

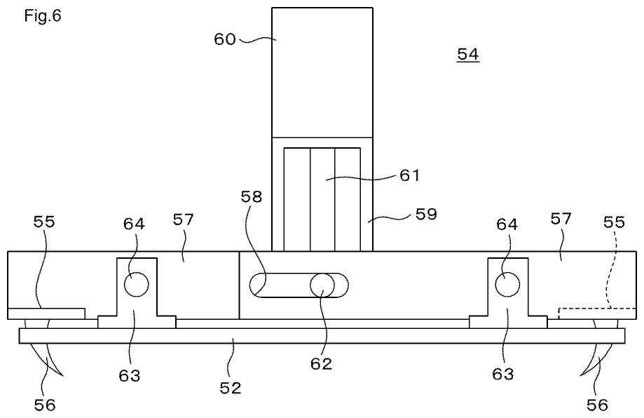

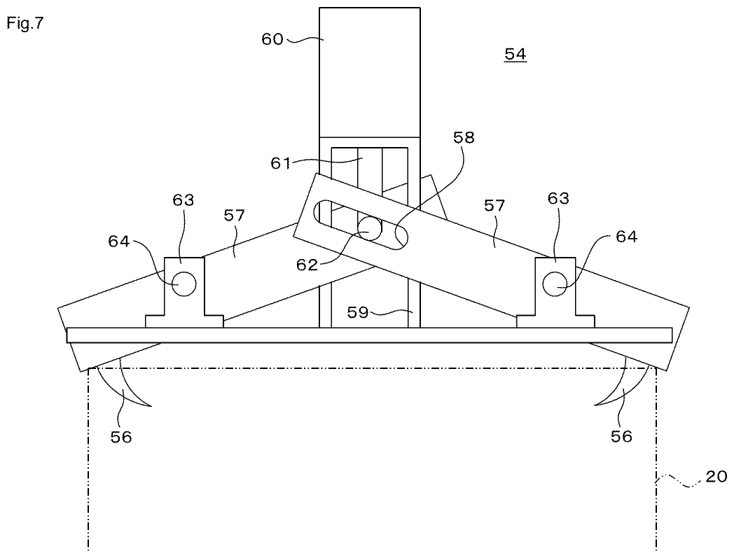

In such a bale rubber holding device 54, when the cylinder 60 advances the rod 61 forward (lower side in FIGS. 6 and 7), while the rod member 62 slides in the elongated holes 58 of the extension portions 57 on both the left and right sides, portions of the elongated holes 58 of the extension portions 57 are pushed forward. The extension portion 57 is displaced in a rotation direction with the shaft member 64 as a rotation axis and the extension portion 57 and the movable portion 55 integrated with the extension portion 57 are parallel to the push plate 52 as illustrated in FIG. 6. The state here is referred to as a state in which the movable portion 55 is open.

When the cylinder 60 moves the rod 61 backward (upper side in FIGS. 6 and 7), while the rod member 62 slides in the elongated holes 58 of the extension portions 57 on both the left and right sides, the portions of the elongated holes 58 of the extension portions 57 are pulled backward. Then, the extension portion 57 is displaced in the rotation direction with the shaft member 64 as the rotation axis and the movable portion 55 integrated with the extension portion 57 comes out forward. Then, when the movable portion 55 moves forward, the claw 56 advances toward the center in the width direction of the push plate 52 as illustrated in FIG. 7. The state here is referred to as a state in which the movable portion 55 is closed.

When the bale rubber 20 contacts the front surface of the push plate 52, if the claw 56 advances toward the center of the push plate 52 in the width direction, as illustrated in FIG. 7, the claw 56 bites into the bale rubber 20 and the claws 56 on both the left and right sides grip the bale rubber 20.

On the back surface of the push plate 52, a mounting portion 65 to which the rod of the above-described cylinder 51 is mounted is provided. The push plate 52 and the bale rubber holding device 54 are integrally sent out by the cylinder 51.

3. Configuration of Cutting Portion

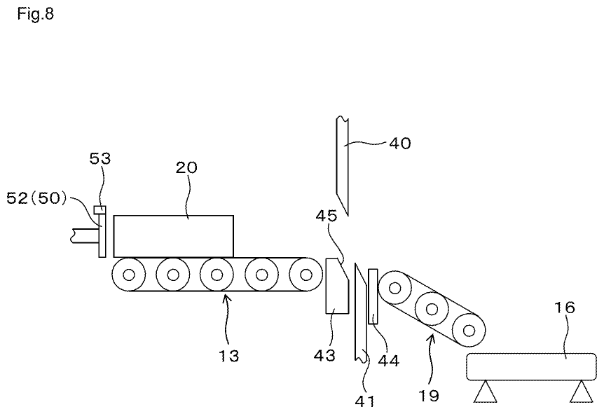

As illustrated in FIG. 8, the cutting portion 18 is provided with the first cutter 40 and the second cutter 41 adjacent to each other. The first cutter 40 and the second cutter 41 are arranged on a plane orthogonal to the feeding direction of the bale rubber 20. The first cutter 40 is located on the constant-rate feed conveyor 13 side and the second cutter 41 is located on the discharge conveyor 19 side.

The first cutter 40 can be moved up and down by the cylinder 42 (see FIGS. 1 and 3) and descends from an upper standby position toward the bale rubber 20. The second cutter 41 can be moved up and down by the cylinder 46 (see FIG. 3) and rises from a lower standby position toward the bale rubber 20. A slight gap exists in a traveling direction of the bale rubber 20 between the first cutter 40 when descending and the second cutter 41 when ascending.

As a part of the cutting portion 18, a first arrangement member 43 is provided between the constant-rate feed conveyor 13 and the first cutter 40 and a second arrangement member 44 is provided between the second cutter 41 and the discharge conveyor 19. An upper surface of the first arrangement member 43 and an upper surface of the second arrangement member 44 are on the same surface as an upper surface of the constant-rate feed conveyor 13. A portion from the upper surface of the first arrangement member 43 to the upper surface of the second arrangement member 44 is a cutting position arranged when the bale rubber 20 is cut.

The first arrangement member 43 is provided with a cutter receiving portion 45 to which a cutting edge of the first cutter 40 descending from above contacts. The cutter receiving portion 45 is formed as an inclined surface along the cutting edge of the first cutter 40. The cutter receiving portion 45 can be displaced in a width direction of the first cutter 40 by the cylinder 47 (see FIG. 3).

The first cutter 40 descends until it contacts the cutter receiving portion 45. Therefore, the first cutter 40 cuts the bale rubber 20 from an upper end to a lower end. On the other hand, the second cutter 41 rises to a position slightly above the upper surface of the second arrangement member 44. Then, the lowering of the first cutter 40 and the ascending of the second cutter 41 are performed in synchronization, but the second cutter 41 supports the bale rubber 20 from below while the first cutter 40 cuts the bale rubber 20.

4. Manufacturing Method of Bale Rubber Piece by Cutting Device

First, manufacturing conditions are input from the input device 28 to the control unit 25. The manufacturing conditions are the number of times one bale rubber 20 is cut, a target weight wₜ of the bale rubber piece 22, and the like. The input may be performed manually by an operator, or may be performed by an imaging unit (not illustrated) reading a work instruction sheet or the like.

Next, the bale rubber 20 wrapped in a resin sheet (not illustrated) is placed on the preparation conveyor 11. The control unit 25, which detects that the bale rubber 20 is placed, drives the motor 35 to rotate the preparation conveyor 11 and drives the motor 36 to rotate the first: measurement conveyor 12, in such a manner that the bale rubber 20 is transported to the center of the first measurement conveyor 12.

When the control unit 25 detects that the bale rubber 20 reached the center of the first measurement conveyor 12, the first weight sensor 38 measures a weight W of the bale rubber 20. The measured weight W is stored in the storage unit in the control unit 25.

The control unit 25 then controls the cylinder 48 to raise the snap cover chain 23 above the roller 31 of the constant-rate feed conveyor 13. Next, the control unit 25 drives the motors 36 and 24 to rotate the first measurement conveyor 12 and the snap cover chain 23. As a result, as illustrated in FIG. 8, the bale rubber 20 is transported to a predetermined position of the constant-rate feed conveyor 13.

Next, the control unit 25 controls the cylinder 51 to move the push plate 52 of the feeding device 50 toward the bale rubber 20 at the predetermined position and stop the push plate 52 at a position where the push plate 52 comes into contact with the bale rubber 20. Here, the movable portion 55 (not illustrated in FIGS. 8 to 11) of the bale rubber holding device 54 is open.

Next, the control unit 25 controls the cylinder 60 and closes the movable portion 55. Then, as illustrated in FIG. 7, the claws 56 provided in the movable portion 55 grip the bale rubber 20 from two directions on the left and right. Here, the claw 56 bites into the rear end portion of the bale rubber 20.

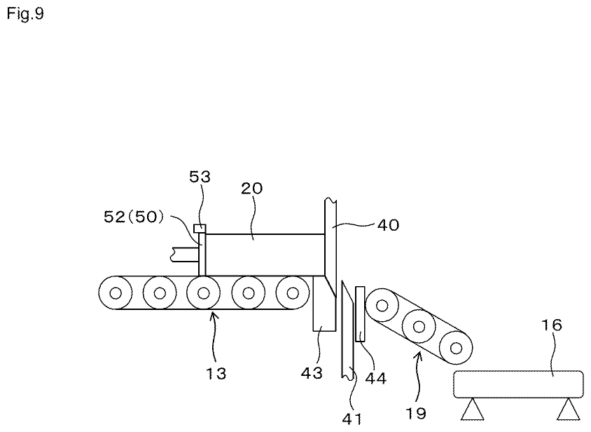

Next, the control unit 25 controls the cylinder 42 to lower the first cutter 40 until the first cutter 40 contacts the cutter receiving portion 45 (see FIG. 9). Next, the control unit 25 controls the cylinder 51 to advance the push plate 52 and the bale rubber holding device 54 toward the first cutter 40 of the cutting portion 18. During the advance operation, the bale rubber holding device 54 is still gripping the bale rubber 20.

As illustrated in FIG. 9, the control unit 25 moves the push plate 52 to the position where the bale rubber 20 contacts the first cutter 40. The bale rubber holding device 54 also moves together with the push plate 52. When the bale rubber 20 contacts the first cutter 40, the control unit 25 stops the movement of the bale rubber holding device 54 and the like. The stop of the bale rubber holding device 54 or the like may be performed when a sensor detects that the bale rubber 20 contacts the first cutter 40, or may be performed when the bale rubber holding device 54 moves by a preset distance.

Next, the control unit 25 measures a distance L from the push plate 52 of the feeding device 50 to the first cutter 40 with the length measuring sensor 53. The distance L measured here coincides with the length of the bale rubber 20 in the feeding direction to the cutting portion 18. The measured distance (length of bale rubber 20) L is stored in the storage unit 26 of the control unit 25.

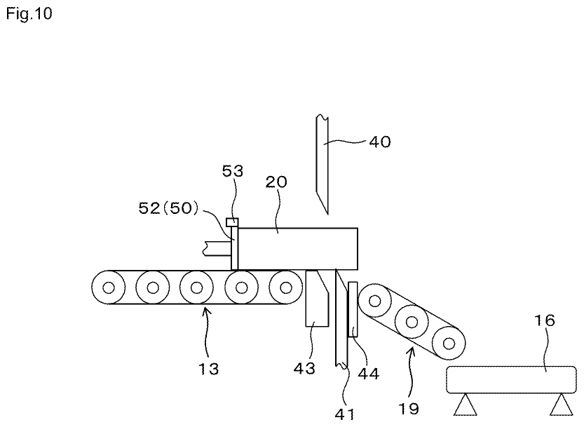

Next, as illustrated in FIG. 10, the control unit 25 raises the first cutter 40. Then, as illustrated in FIG. 10, the bale rubber 20 is sent out by the feeding device 50. During feeding, the bale rubber holding device 54 continues to grip the bale rubber 20. The feeding puts the bale rubber 20 under the first cutter 40. A feed distance Sₙ (Sₙ means the n-th feed distance, and n=1 in the case of the first feeding as here) by the feeding device 50 here will be described below.

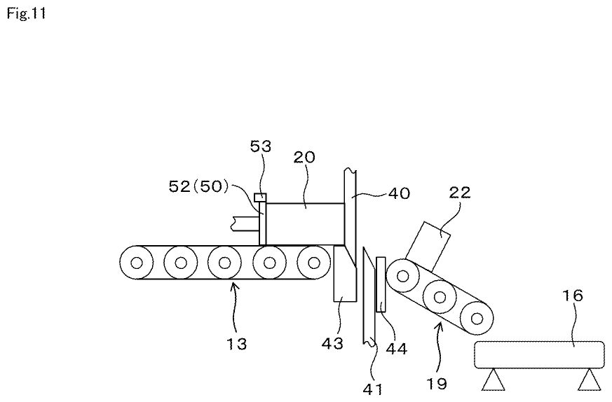

Next, as illustrated in FIG. 11, the control unit 25 lowers the first cutter 40 and at the same time raises the second cutter 41. Here, the first cutter 40 descends until it contacts the cutter receiving portion 45, but the second cutter 41 rises only slightly above the second arrangement member 44. Therefore, the bale rubber 20 is cut by the descending first cutter 40 while being supported by the second cutter 41 from below. The second cutter 41 may make a notch in a lower part of the bale rubber 20. Even during the cutting of the bale rubber 20, the bale rubber holding device 54 continues to grip the bale rubber 20.

At the same time that the lowered first cutter 40 contacts the cutter receiving portion 45, or after the lowered first cutter 40 contacts the cutter receiving portion 45, the control unit 25 controls the cylinder 47 to displace the cutter receiving portion 45 in the width direction (left-right direction) of the first cutter 40. As a result, even when the lower end of the bale rubber 20 and the resin sheet wrapping the bale rubber 20 remain uncut, the remaining portion is torn off between the first cutter 40 and the cutter receiving portion 45.

The second cutter 41 may be displaced in the width direction (left-right direction) of the second cutter 41 while rising or after being raised due to cutting of the bale rubber 20.

The bale rubber piece 22 made by such cutting is transported to the second measurement conveyor 16 by the discharge conveyor 19. When the control unit 25 detects that the bale rubber piece 22 has reached the second measurement conveyor 16, the control unit 25 measures the weight wₙ (wₙ is the weight of the n-th bale rubber piece 22, and in the case of the first one as here, n=1) of the bale rubber piece 22 with the second weight sensor 39. The measured weight wₙ of the bale rubber piece 22 is stored in the storage unit 26 of the control unit 25.

When the weight of the bale rubber piece 22 meets acceptance criteria, the control unit 25 controls the motor 37 to rotate the second measurement conveyor 16 and transports the bale rubber piece 22 to the non-defective product box 14. On the other hand, when the weight of bale rubber piece 22 does not meet the acceptance criteria, the control unit 25 controls the motor 37 to rotate the second measurement conveyor 16 and transports the bale rubber piece 22 to the defective product box 17.

The control unit 25 sends out the bale rubber 20 again by the feeding device 50 after the first cutting of the bale rubber 20 and performs the second cutting. The control unit 25 repeats feeding by the feeding device 50 and cutting by the first cutter 40 until the entire bale rubber 20 is divided into a plurality of bale rubber pieces 22. The second and subsequent feed distance Sₙ by the feeding device 50 will be described below.

The bale rubber holding device 54 continues to grip the rear end portion of the bale rubber 20 until the final cutting of the bale rubber 20 is completed. After the final cutting of the bale rubber 20, the control unit 25 opens the movable portion 55 of the bale rubber holding device 54 to release the remaining bale rubber 20 (that is, the last bale rubber piece 22) from the bale rubber holding device 54. Then, the control unit 25 pushes the last bale rubber piece 22 to the discharge conveyor 19 with the push plate 52.

5. Method for Determining Feed Amount of Bale Rubber

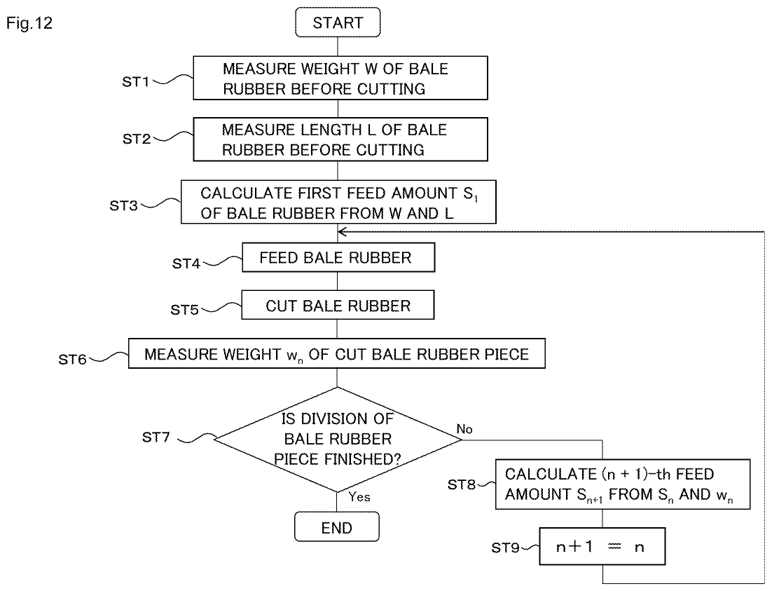

Here, a method for determining the feed distance Sₙ of the bale rubber 20 by the feeding device 50 will be described based on a flowchart of FIG. 12.

First, as described above, the first weight sensor 38 measures the weight W of the bale rubber 20 before cutting on the first measurement conveyor 12 (ST1). The measured weight W is stored in the storage unit 26 of the control unit 25.

Next, as described above, the length measuring sensor 53 measures the length L of the bale rubber 20 before cutting pressed against the first cutter 40 by the feeding device 50 (ST2). The measured length L is stored in the storage unit 26 of the control unit 25.

The calculation unit 27 of the control unit 25 calculates a first feed amount (feed distance) S₁ of the bale rubber 20 by the feeding device 50 after measuring the length L of the bale rubber 20 (ST3). The feed distance S₁ is calculated by the following equation so that when the length of the bale rubber piece 22 becomes S₁, the weight of the bale rubber piece 22 becomes a target weight wₜ. The target weight wₜ of the bale rubber piece 22 is stored in the storage unit 26 in advance by an operator.

S₁=wₜ×L/W [Equation 1]

Next, the control unit 25 controls the feeding device 50 and sends the bale rubber 20 forward (in a direction of the first cutter 40) by the obtained distance S₁ (ST4). Next, the control unit 25 controls the first cutter 40 and the second cutter 41 to cut the bale rubber 20 and cut out the bale rubber piece 22 having a length S₁ (ST5).

Next, as described above, the second weight sensor 39 provided on the second measurement conveyor 16 measures a weight w₁ of the cut-out bale rubber piece 22 (ST6). The measured weight w₁ is stored in the storage unit 26 of the control unit 25.

Next, the control unit 25 determines whether the entire bale rubber 20 is divided into the bale rubber pieces 22 (ST7).

For example, a sensor detects the amount of the bale rubber 20 remaining further on the feeding device 50 side than the first cutter 40. When the detected amount is equal to or more than a predetermined amount, it is determined that the division is not completed, and when the detected amount is less than the predetermined amount, it is determined that the division is completed.

Alternatively, the number of cuts required to divide the entire bale rubber 20 into the bale rubber piece 22 is set in advance in the control unit 25. The control unit 25 determines that the division of the bale rubber 20 is not completed when the cutting of the set number of cuts is not completed. When the cutting of the set number of cuts is completed, it is determined that the division of the bale rubber 20 is completed.

Anyway, when the control unit 25 determines that the division of the bale rubber 20 is not completed (No in ST7), the control unit 25 proceeds to a next step (ST8, ST9). On the other hand, when the control unit 25 determines that the division of the bale rubber 20 is completed (Yes in ST7), the control unit 25 ends the above flow.

In the present embodiment, it is assumed that the bale rubber 20 is cut 10 to 15 times. Therefore, when the above-described first cutting is completed, the control unit 25 determines that the division of the bale rubber 20 is not completed (No in ST7). Therefore, the flow proceeds to the next step (ST8, ST9).

In the next step (ST8, ST9), the calculation unit 27 calculates a distance S₂ of second feeding of the bale rubber 20 so that a weight w₂ of the bale rubber piece 22 cut out the second time can be brought closer to the target weight wₜ. Specifically, the calculation unit 27 calculates the distance S₂ of the second feeding by the following equation using the weight w₁ of the bale rubber piece 22 cut out immediately before.

$${S}_{2} = \frac{{w}_{t} \times {S}_{1}}{{w}_{1}} \qquad [ Equation 2 ]$$

That is, although a cross-sectional area (area in a plane orthogonal to the feeding direction) of the bale rubber 20 changes depending on the location, it is assumed that the cross-sectional area is approximately the same at the location of the bale rubber piece 22 cut out the first time and the location of the bale rubber piece 22 cut out the second time. Based on the assumption, it can be said that the weight per unit length of the bale rubber piece 22 cut out the second time matches the weight w₁/S₁ per unit length of the bale rubber piece 22 cut out the first time. Therefore, the target weight wₜ of the bale rubber piece 22 is divided by the weight w₁/S₁ per unit length of the bale rubber piece 22 to determine the distance S₂ for the second feeding.

When the distance S₂ for the second feeding is determined, the process returns to a step (ST4) of feeding the bale rubber 20 and the feeding device 50 feeds the bale rubber 20 by the distance S₂. The first cutter 40 cuts out the second bale rubber piece 22 and the weight w₂ of the bale rubber piece 22 is measured by the second weight sensor 39.

After that, the control unit 25 repeats the routine after ST4 until it is determined that the division of the bale rubber 20 is completed (Yes in ST7). In the routine, the (n+1)-th feed distance Sₙ₊₁ of the bale rubber 20 is calculated by the following generalized equation using the n-th feed distance Sₙ and the weight wₙ of the bale rubber piece 22 cut out at the n-th time.

$${S}_{n + 1} = \frac{{w}_{t} \times {S}_{n}}{{w}_{n}} \qquad [ Equation 3 ]$$

6. Effect of Embodiment

As described above, the bale rubber holding device 54 of the present embodiment can grip the rear portion of the bale rubber 20. Therefore, it is possible to prevent the bale rubber 20 from being displaced when the bale rubber 20 is cut, and thus it becomes easy to cut out the bale rubber piece 22 with accurate dimensions.

Here, since the bale rubber holding device 54 grips the rear portion of the bale rubber 20 by interposing it from two directions, the bale rubber 20 can be firmly gripped. Since the bale rubber holding device 54 includes the claw 56 which bites into the bale rubber 20, the bale rubber 20 can be firmly gripped.

In the embodiment, the bale rubber holding device 54 continues to grip the rear portion of the bale rubber 20 while the bale rubber 20 is cut by the first cutter 40 (that is, during one cutting operation by the first cutter 40). Therefore, it is possible to prevent the bale rubber 20 from being displaced during cutting.

In the embodiment, the bale rubber holding device 54 continues to grip the rear portion of the bale rubber 20 while the bale rubber 20 is cut by the first cutter 40 a plurality of times. Therefore, it is possible to prevent the bale rubber 20 from being displaced between the first cutting and the second cutting.

7. Modification Example

Various modifications can be made to the embodiment described above.

For example, as a bale rubber holding device, various devices capable of gripping the rear portion of the bale rubber 20 can be applied.

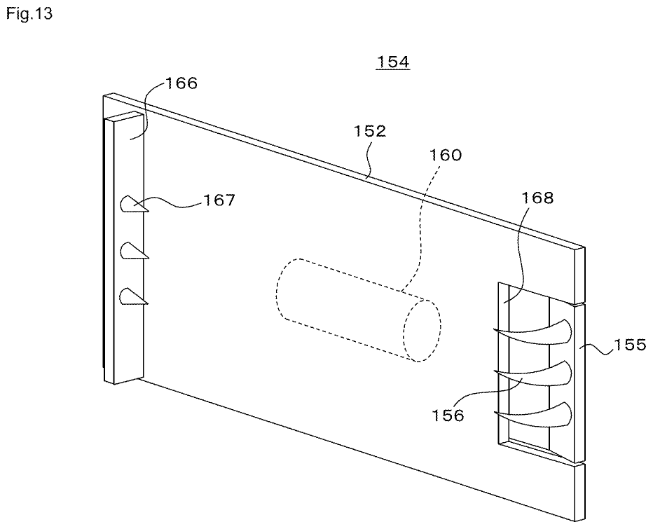

A bale rubber holding device 154 shown in FIG. 13 is an example of a device including a claw which bites into the bale rubber 20 and gripping the rear portion of the bale rubber 20 by interposing it from two directions.

The bale rubber holding device 154 is provided for a push plate 152 corresponding to the push plate 52 in the embodiment described above. A rib 166 extending in the up-down direction is fixed to one (left side in the case of FIG. 13) of the left and right sides of the front surface of the push plate 152. The rib 166 is provided with three small claws 167 arranged in the up-down direction. The small claws 167 extend toward the center of the push plate 152 in the left-right direction and have a sharp tip.

On the other side (on the right side in the case of FIG. 13) of the push plate 152 in the left-right direction, a notch 168 having a shape notched at a central portion in the up-down direction is formed. A movable portion 155 is provided at a location of the notch 168. A cylinder 160 is provided on the rear surface of the push plate 152 and the movable portion 155 can be moved in the left-right direction by the cylinder 160.

Three large claws 156 arranged in the up-down direction are provided on a front surface of the movable portion 155. The large claws 156 project forward from the notch 168 of the push plate 152. The large claws 156 are curved toward the center in the left-right direction (width direction) of the push plate 152 and the tips thereof are sharpened.

In such a bale rubber holding device 154, when the cylinder 160 moves the movable portion 155 away from the small claw 167, a distance from a tip of the large claw 156 provided in the movable portion 155 to a tip of the small claw 167 is wider than a width of the bale rubber 20.

Here, the bale rubber 20 is arranged between the tip of the large claw 156 and the tip of the small claw 167. Next, the cylinder 160 moves the movable portion 155 closer to the small claw 167. As a result, the distance from the tip of the large claw 156 to the tip of the small claw 167 becomes narrower than the width of the bale rubber 20 and the large claw 156 and the small claw 167 bite into the bale rubber 20. The large claw 156 and the small claw 167 can grip the rear portion of the bale rubber 20 from two directions.

1. A bale rubber holding device which is provided in a feeding device which feeds a bale rubber, which is a lump of rubber, forward toward a cutting position, wherein
the bale rubber holding device grips a rear portion of the bale rubber.

2. The bale rubber holding device according to claim 1, wherein
the bale rubber holding device grips the rear portion of the bale rubber by interposing it from two directions.

3. The bale rubber holding device according to claim 1, wherein
the bale rubber holding device includes a claw which bites into the bale rubber.

4. The bale rubber holding device according to claim 1, wherein
the bale rubber holding device continues to grip the rear portion of the bale rubber while the bale rubber is cut at the cutting position.

5. The bale rubber holding device according to claim 1, wherein
the bale rubber is cut a plurality of times at the cutting position, and
the bale rubber holding device continues to grip the rear portion of the bale rubber while the bale rubber is cut a plurality of times at the cutting position.

6. A method for cutting a bale rubber which includes feeding the bale rubber forward toward a cutting position and cutting the bale rubber at the cutting position, wherein
at least while the bale rubber is cut, a bale rubber holding device provided in a feeding device which feeds the bale rubber grips a rear portion of the bale rubber.

7. The method for cutting the bale rubber according to claim 6, wherein
the bale rubber holding device grips the rear portion of the bale rubber by interposing it from two directions.

8. The method for cutting the bale rubber according to claim 6, wherein
a claw is provided in the bale rubber holding device, and
the bale rubber holding device bites the claw into the bale rubber and grips it.

9. The method for cutting the bale rubber according to claim 6, wherein
the bale rubber is cut a plurality of times at the cutting position, and
the bale rubber holding device continues to grip the rear portion of the bale rubber while the bale rubber is cut a plurality of times at the cutting position.
